(19) United States
(12) Patent Application Publication
(10) Pub. No.: US 2025/0294300 A1
(43) Pub. Date: Sep. 18, 2025

(54) MIXING SPEECH AND NOISE IN AN EAR-WORN DEVICE BASED ON NOISE LEVEL

(71) Applicant: Chromatic Inc., New York, NY (US)

(72) Inventors: Igor Lovchinsky, New York, NY (US); Israel Malkin, Manhattan Beach, CA (US); Philip Meyers, IV, San Francisco, CA (US); Nathan Agmon, New York, NY (US); Nicholas K. Morris, Brooklyn, NY (US)

(21) Appl. No.: 19/081,230

(22) Filed: Mar. 17, 2025

Related U.S. Application Data
(60) Provisional application No. 63/566,434, filed on Mar. 18, 2024.

(51) Int. Cl. H04R 25/00

(52) U.S. Cl. CPC H04R 25/507; H04R 25/43; H04R 2225/43

(57) ABSTRACT

An ear-worn device may include neural network circuitry configured to determine, using a neural network, one or both of a neural network-predicted speech component of an input audio signal and a neural network-predicted noise component of the input audio signal. The ear-worn device may further include mixing circuitry configured to perform mixing resulting in an output signal corresponding to the neural network-predicted speech component of the input audio signal mixed with the neural network-predicted noise component of the input audio signal. The ear-worn device may further include adaptive mixing control circuitry configured to control the mixing performed by the mixing circuitry based, at least in part, on a level of an estimate of a stationary noise component of the input audio signal and/or a level of the neural network-predicted noise component of the input audio signal.

### BACKGROUND

The present disclosure relates to noise reduction in an ear-worn device. In particular, the present disclosure relates to mixing speech and noise in an ear-worn device based on noise level.

### BRIEF DESCRIPTION OF DRAWINGS

Various aspects and embodiments of the application will be described with reference to the following figures. It should be appreciated that the figures are not necessarily drawn to scale. Items appearing in multiple figures are indicated by the same reference number in all the figures in which they appear.

FIG. 1 illustrates a data path in an ear-worn device (e.g., a hearing aid, cochlear implant, or earphone), in accordance with certain embodiments described herein;

FIG. 2 illustrates noise reduction circuitry in more detail, in accordance with certain embodiments described herein;

FIG. 3 illustrates noise reduction circuitry in more detail, in accordance with certain embodiments described herein;

FIG. 4 illustrates an example function of weight applied to the neural network-predicted noise component as a function of level of the noise component of the input audio signal, in accordance with certain embodiments described herein;

FIG. 5 illustrates an example function of weight applied to the neural network-predicted noise component as a function of level of the noise component of the input audio signal, in accordance with certain embodiments described herein;

FIG. 6 illustrates an example function of weight applied to the neural network-predicted noise component as a function of level of the noise component of the input audio signal, in accordance with certain embodiments described herein;

FIG. 7 illustrates an example function of weight applied to the neural network-predicted noise component as a function of level of the noise component of the input audio signal, in accordance with certain embodiments described herein;

FIG. 8 illustrates an example function of relative weight applied to the neural network-predicted noise component versus the neural network-predicted speech component as a function of level of the noise component of the input audio signal, in accordance with certain embodiments described herein;

FIG. 9 illustrates an example function of relative weight applied to the neural network-predicted noise component versus the neural network-predicted speech component as a function of level of the noise component of the input audio signal, in accordance with certain embodiments described herein;

FIG. 10 illustrates an example function of relative weight applied to the neural network-predicted noise component versus the neural network-predicted speech component as a function of level of the noise component of the input audio signal, in accordance with certain embodiments described herein;

FIG. 11 illustrates an example function of relative weight applied to the neural network-predicted noise component versus the neural network-predicted speech component as a function of level of the noise component of the input audio signal, in accordance with certain embodiments described herein;

FIG. 12 illustrates a hearing aid, in accordance with certain embodiments described herein.

### DETAILED DESCRIPTION

Recently, noise reduction neural networks have been developed. Such neural networks may have applications, for example, in ear-worn devices, such as hearing aids, cochlear implants, and earphones. Further description of such neural networks may be found in U.S. Pat. No. 11,812,225, titled METHOD, APPARATUS AND SYSTEM FOR NEURAL NETWORK HEARING AID, and issued on Nov. 7, 2023, which is incorporated by reference herein in its entirety; in U.S. Pat. No. 11,902,747, titled “HEARING LOSS AMPLIFICATION THAT AMPLIFIES SPEECH AND NOISE SUBSIGNALS DIFFERENTLY,” and issued on Feb. 13, 2024, which is incorporated by reference herein in its entirety; and in U.S. Pat. No. 11,937,047, titled “Ear-worn device with neural network for noise reduction and/or spatial focusing using multiple input audio signals,” and issued on Mar. 19, 2024, which is incorporated by reference herein in its entirety.

Using a neural network, noise reduction circuitry may be configured to determine a neural network-predicted speech component and a neural network-predicted noise component of an input audio signal. The input audio signal may be enhanced by outputting the speech component mixed with an attenuated version of the noise component. Mixing back some of the noise component into the speech component of the input audio signal, rather than removing the noise component completely, may be beneficial, for example by helping to reduce distortion and also enabling some environmental awareness for the wearer of the ear-worn device. The inventors have recognized that the weight applied to the noise component in the mixing process may be based, at least in part, on characteristics of the input audio signal. For purposes of explanation, refer to the neural network-predicted speech component as Speech_nn and the neural network-predicted noise component as Noise_nn. In some embodiments, the noise reduction circuitry may perform mixing that results in Speech_nn+a*Noise_nn, where a is the weight that controls attenuation of the noise component. One option may be to modulate the weight a based on the signal-to-noise ratio (SNR) of the input audio signal. For example, in a low-SNR environment, a may be increased relative to a value of a in a high-SNR environment. However, the inventors have recognized that when there is no speech (e.g., when nobody is talking), the SNR may be infinitely negative, and that may cause a to be high until there is speech, at which point a drops, producing a pumping effect.

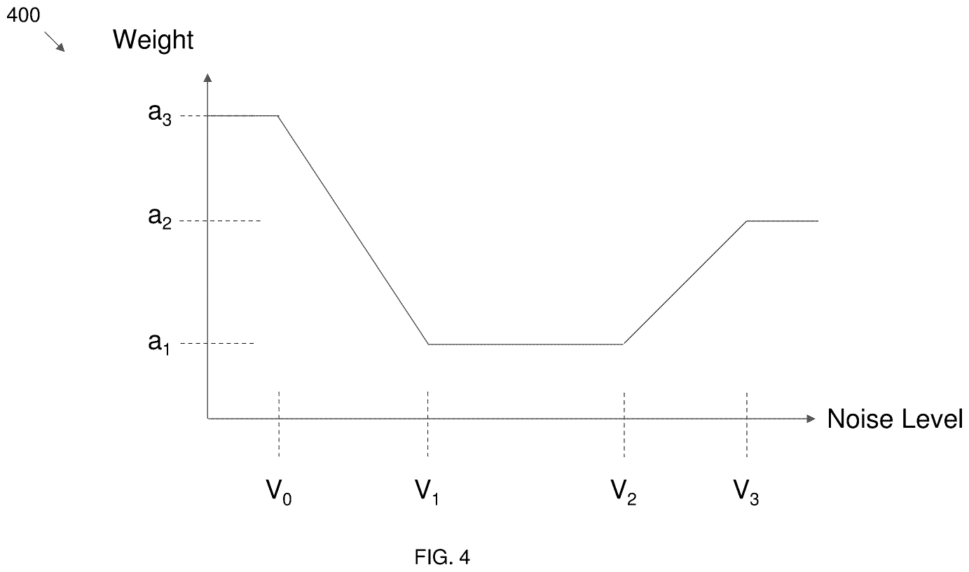

Instead of basing the weight a on the SNR of the input audio signal, the inventors have recognized that basing a, at least in part, on the noise level may avoid such pumping effects. For example, the noise level may be calculated for a slow-moving estimate of the stationary noise component of the input audio signal, or may be calculated for the neural network-predicted noise component of the input audio signal. The inventors have additionally developed functions for the relationship between a and noise level. For example, the inventors have recognized that it may be helpful to mix more noise together with speech when the noise volume of the environment is lower than when the noise volume of the environment is higher. This is because artifacts (e.g., due to operation of the neural network) may be more noticeable at lower noise volumes, and because less noise reduction may be necessary at lower noise volumes. As another example, the inventors have recognized that it may be helpful to mix more noise together with speech at very high noise volume environments. This is because the neural network may perform less well at very high noise volume environments and so there may be more artifacts. Based on these relationships, the functions of a vs. noise level may have a U-shape or a Z-shape, as illustrated in FIGS. 4-7 and described further below.

The aspects and embodiments described above, as well as additional aspects and embodiments, are described further below. These aspects and/or embodiments may be used individually, all together, or in any combination of two or more, as the disclosure is not limited in this respect.

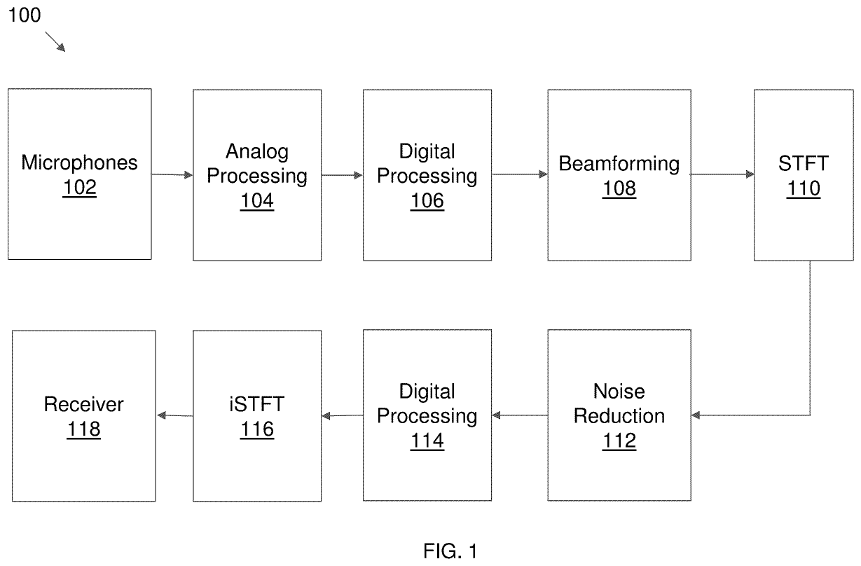

FIG. 1 illustrates a data path 100 in an ear-worn device (e.g., a hearing aid, cochlear implant, or earphone), in accordance with certain embodiments described herein. The data path 100 includes microphones 102, analog processing circuitry 104, digital processing circuitry 106, beamforming circuitry 108, short-time Fourier transformation (STFT) circuitry 110, noise reduction circuitry 112, digital processing circuitry 114, inverse STFT (iSTFT) circuitry 116, and a receiver 118. It should be appreciated that the data path 100 may include more circuitry and components than shown (e.g., anti-feedback circuitry, calibration circuitry, etc.) and such circuitry and components may be disposed before, after, or between the circuitry and components illustrated in FIG. 1.

In the data path 100, the analog processing circuitry 104 is coupled between the microphones 102 and the digital processing circuitry 106. The digital processing circuitry 106 is coupled between the analog processing circuitry 104 and the beamforming circuitry 108. The beamforming circuitry 108 is coupled between the digital processing circuitry 106 and the STFT circuitry 110. The STFT circuitry 110 is coupled between the beamforming circuitry 108 and the noise reduction circuitry 112. The noise reduction circuitry 112 is coupled between the STFT circuitry 110 and the digital processing circuitry 114. The digital processing circuitry 114 is coupled between the noise reduction circuitry 112 and the inverse STFT circuitry 116. The inverse STFT 116 circuitry is coupled between the digital processing circuitry 114 and the receiver 118. As referred to herein, if element A is described as coupled between element B and element C, there may be other elements between elements A and B and/or between elements A and C.

The microphones 102 may be configured to receive sound signals and convert the sound signals into electrical audio signals. The microphones 102 may be disposed on the external housing of the ear-worn device. In some embodiments, one of the microphones may be closer to the front of the wearer of the ear-worn device and the other microphone may be closer to the back of the wearer of the ear-worn device.

The analog processing circuitry 104 may be configured to perform analog processing on the electrical signals received from the microphones 102. For example, the analog processing circuitry 104 may be configured to perform one or more of analog preamplification, analog filtering, and analog-to-digital conversion.

The digital processing circuitry 106 may be configured to perform digital processing on the signals received from the analog processing circuitry 104. For example, the digital processing circuitry 106 may be configured to perform one or more of wind reduction, input calibration, and anti-feedback processing.

The beamforming circuitry 108 may be configured to perform beamforming on the signals received from the digital processing circuitry 106. In some embodiments, the beamforming circuitry 108 may be configured to generate a front input audio signal based on a beam pattern steered towards a front direction of a wearer of the ear-worn device. For example, if one of the microphones 102 is closer to the front of the wearer and one of the microphones 102 is closer to the back of the wearer, then the beamforming circuitry 108 may be configured to sum the processed signal from the front microphone with an inverted and delayed version of the processed signal from the rear microphone. The resulting signal may have no (or approximately no) signal attenuation towards the front of the wearer, complete (or approximately complete) signal attenuation directly to the back of the wearer, and be attenuated on the sides of the wearer, e.g., by approximately 6 dB. Thus, the beamforming circuitry 108 may be configured to focus the sound processed by the ear-worn device towards the front of the wearer, where signals of interest typically originate.

The STFT circuitry 110 may be configured to perform STFT on the beamformed signals. The STFT may convert a signal within a short time window (e.g., on the order of milliseconds) into a frequency-domain signal.

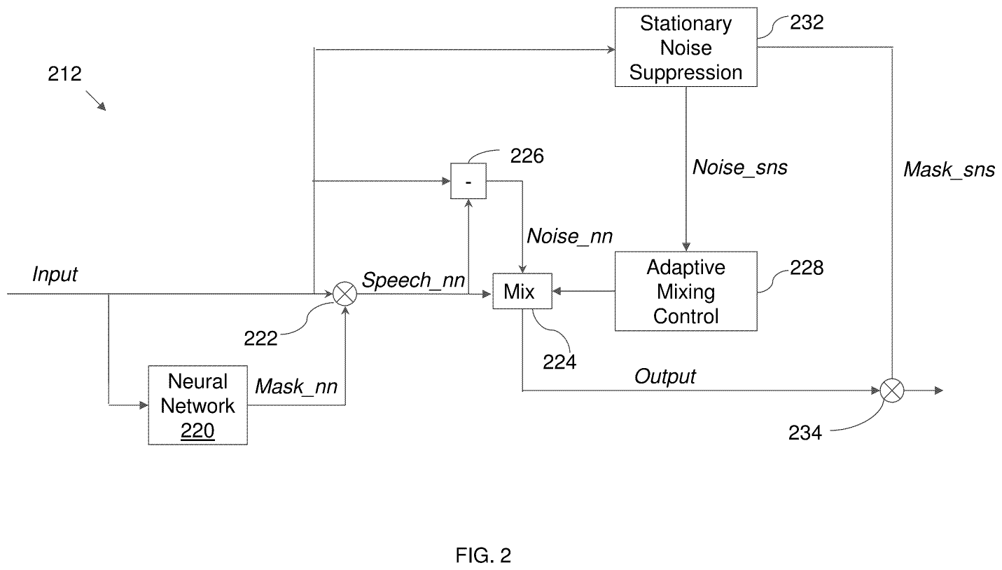

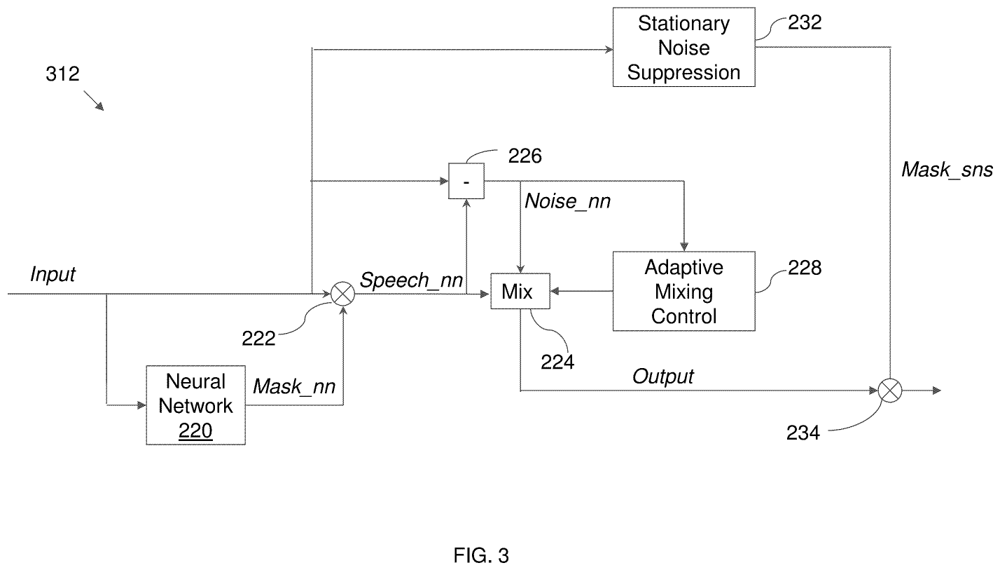

The noise reduction circuitry 112 may be configured to implement a neural network (e.g., a recurrent neural network, or some other type of neural network such as vanilla/feedforward, convolutional, generative adversarial, attention (e.g. transformer), or graphical) trained to denoise input audio signals. Further description of the noise reduction circuitry may be found with reference to FIGS. 2 and 3.

The digital processing circuitry 114 may be configured to perform further digital processing on the signal received from the noise reduction circuitry 112. For example, the digital processing circuitry 114 may be configured to perform one or more of wide-dynamic range compression and output calibration.

The inverse STFT (iSTFT) circuitry 116 may be configured to perform inverse STFT on the signals received from the digital processing circuitry 114. The iSTFT may convert a frequency-domain signal into a time-domain signal having a short time window. It should be appreciated that some data paths operating in the time domain may lack the STFT circuitry 110 and the iSTFT circuitry 116. Additionally, certain digital processing steps may occur downstream of the iSTFT.

The receiver 118 may be configured to play back the signal received from the iSTFT circuitry 116 as sound into the ear of the user. The receiver 118 may also implement digital-to-analog conversion prior to the playing back.

FIG. 2 illustrates noise reduction circuitry 212 (which may correspond to the noise reduction circuitry 112) in more detail, in accordance with certain embodiments described herein. The noise reduction circuitry 212 includes neural network circuitry 220 configured to implement a neural network. In some embodiments, the neural network may be trained to denoise input audio signals. Further description of such neural networks may be found in U.S. Pat. No. 11,812,225, titled METHOD, APPARATUS AND SYSTEM FOR NEURAL NETWORK HEARING AID, and issued on Nov. 7, 2023, which is incorporated by reference herein in its entirety; U.S. Pat. No. 11,902,747, titled “HEARING LOSS AMPLIFICATION THAT AMPLIFIES SPEECH AND NOISE SUBSIGNALS DIFFERENTLY,” and issued on Feb. 13, 2024, which is incorporated by reference herein in its entirety; and U.S. Pat. No. 11,937,047, titled “Ear-worn device with neural network for noise reduction and/or spatial focusing using multiple input audio signals,” and issued on Mar. 19, 2024, which is incorporated by reference herein in its entirety. In some embodiments, denoising an input audio signal may include generating a mask that, when multiplied by the input audio signal, results in a neural network-predicted speech component of the input audio signal. In more detail, the neural network circuitry 220 may be configured to take an input audio signal (referred to as Input in FIG. 2 and, for example, corresponding to the output of STFT circuitry as in FIG. 1 with further pre-processing) and output a mask (referred to as Mask_nn in FIG. 2) that, when multiplied by the input audio signal, leaves just the neural network-predicted speech component of Input remaining. The neural network implemented by the neural network circuitry 220 may be trained to output masks based on training input audio signals and masks that result in the input audio signals' speech-isolated components. Generally, a component of Input may be considered neural-network predicted when the component is determined by a neural network or using an output (e.g., a mask) that is determined by a neural network. In some embodiments, the neural network circuitry 220 may be configured to receive multiple input audio signals (e.g., with different beamformed patterns, and Input may be one of such signals).

The multiplier 222 may be configured to multiply Input by Mask_nn. This may produce a result corresponding to just the neural network-predicted speech component of the input audio signal (referred to as Speech_nn in FIG. 2). The subtractor 226 may be configured to subtract Speech_nn from Input, resulting in the neural network-predicted noise component of Input (referred to as Noise_nn in FIG. 2), in other words, a signal containing everything but the neural network-predicted speech component of the input audio signal. In the above example, Speech_nn may be considered neural network-predicted because it is generated by multiplying Input by Mask_nn, a neural network-generated mask. Noise_nn may be considered neural network-predicted because it is generated by subtracting Speech_nn from Input, and Speech_nn itself is neural network-predicted.

The mixing circuitry 224 may be configured to mix Speech_nn with Noise_nn to produce a denoised audio signal. In more detail, the mixing circuitry 224 may be configured to output the neural network-predicted speech component of the input audio signal plus the neural network-predicted noise component of the input audio signal multiplied by a particular weight. Thus, the output of the mixing circuitry 224 may be Speech_nn+a*Noise_nn, where a, the weight, is 0, 1, or a number in between 0 and 1. (However, other embodiments may perform mixing such as b*Speech_nn+a*Noise_nn, where a and b are weights.) Thus, the output of the mixing circuitry 224 may include less noise than the input audio signal, and therefore may represent a noise-reduced version of the input audio signal. Mixing back some noise into the speech component of the input audio signal may help to reduce distortion and also enable some environmental awareness for the wearer of the ear-worn device. It should be appreciated that both Speech_nn and Noise_nn may be generated from Input, which may have been processed by the analog processing circuitry 104, the digital processing circuitry 106, the beamforming circuitry 108, and the STFT circuitry 110. In other words, there might be no unprocessed signals involved in the mixing. In some embodiments, the weight a may be different for different frequency channels based on the different noise level in different frequency channels. Thus, a may be a frequency-dependent weight in at least some embodiments. In some embodiments, the weight a may be the same for different frequency channels (e.g., based on an average of the noise level across different frequency channels).

Generally, in some embodiments the mixing circuitry 224 may be configured to receive two signals, mix them, and generate an output signal Output corresponding to the neural network-predicted speech component of the input audio signal mixed with the neural network-predicted noise component of the input audio signal. At least one of the two received signals may be a neural network-predicted signal (e.g., a neural network-predicted speech component of an input audio signal and/or a neural network-predicted noise component of an input audio signal). In some such embodiments, the mixing circuitry 224 may be configured to perform this mixing (i.e., mix the two received signals) such that the output signal Output has a component that is a weighted version of the neural-network predicted signal. For example, the output signal Output may have a component equivalent to the neural network-predicted noise component multiplied by a weight. Thus, in some embodiments, the mixing circuitry 224 may be configured to output Speech_nn+a*Noise_nn. (However, in some embodiments, the mixing circuitry 224 may be configured to output b*Speech_nn+a*Noise_nn). In the example noise reduction circuitry 212 and the example noise reduction circuitry 312 of FIG. 3, the mixing circuitry 224 may take as inputs Speech_nn and Noise_nn and produce Speech_nn+a*Noise_nn. It should be appreciated that the mixing circuitry 224 may be configured to take other inputs and still produce a signal Output corresponding to Speech_nn+a*Noise_nn, given that Input is equal to Speech_nn+Noise_nn. In other words, both Speech_nn and Noise_nn may not necessarily be inputs to the mixing. In some embodiments, the mixing circuitry 224 may be configured to take Input and Speech_nn as inputs and produce (1−a)*Speech_nn+a*Input, which corresponds to Speech_nn+a*Noise_nn. In some embodiments, the mixing circuitry 224 may be configured to take Input and Noise_nn as inputs and produce Input+(a−1)*Noise_nn, which corresponds to Speech_nn+a*Noise_nn.

It should be appreciated from the above that either Speech_nn and Noise_nn, Speech_nn and Input, or Noise_nn and Input may be the inputs to the mixing (as non-limiting examples). Thus, in some embodiments, the noise reduction circuitry 212 may be configured to generate both Speech_nn and Noise_nn, while in some embodiments, the noise reduction circuitry 212 may be configured to generate only one of Speech_nn and Noise_nn. In embodiments that include generating Speech_nn and Noise_nn, in some embodiments, the neural network may be trained to output a mask that generates Speech_nn (e.g., by multiplying the mask by Input), and then Speech_nn may be subtracted from Input to generate Noise_nn (as in FIGS. 2 and 3). In other embodiments, the neural network may be trained to output a mask that generates Noise_nn (e.g., by multiplying by Input) and then Noise_nn may be subtracted from Input to generate Speech_nn. In embodiments that include generating Speech_nn but not Noise_nn, in some embodiments, the neural network may be trained to output a mask that generates Speech_nn. In embodiments that include generating Noise_nn but not Speech_nn, in some embodiments, the neural network may be trained to output a mask that generates Noise_nn. When a mask generates Speech_nn, the neural network may be trained to output masks based on training input audio signals and masks that result in the input audio signals' speech-isolated components. When a mask generates Noise_nn, the neural network may be trained to output masks based on training input audio signals and masks that result in the input audio signals' noise-isolated components.

As described above, the neural network implemented by the neural network circuitry 220 may be trained to generate a mask Mask_nn that, when multiplied by Input, results in Speech_nn, as shown in FIG. 2. In some embodiments, the neural network implemented by the neural network circuitry 220 may be trained to generate a mask that, when multiplied by Input, results in Noise_nn. In some embodiments, the mask may be added to Input, rather than multiplied. In some embodiments, the neural network implemented by the neural network circuitry 220 may be trained to generate Speech_nn directly, rather than a mask. In some embodiments, the neural network implemented by the neural network circuitry 220 may be trained to generate Noise_nn directly, rather than a mask.

As further illustrated in FIG. 2, the noise reduction circuitry 212 includes stationary noise suppression (SNS), or stationary noise reduction, circuitry 232. In some embodiments, the neural network implemented by the neural network circuitry 220 may be particularly effective in reducing non-stationary noise, and separate stationary noise suppression may be implemented. Thus, the SNS circuitry 232 may be configured to receive Input, generate an estimate of the stationary noise component of Input (referred to as Noise_sns), and generate a mask (referred to as Mask_sns) based on Noise_sns. The estimate of the stationary noise component may be slow-moving. Qualitatively, the slow-moving estimate of the stationary noise component of Input may generally not change substantially over the timescale of a few seconds. Quantitatively, in some embodiments the slow-moving estimate of the stationary noise component of Input may be asymmetric in that it may be permitted to get smaller over a relatively fast timescale (e.g., in the range of 1-100 milliseconds) but may be permitted to get larger only over a very long timescale (e.g., in the range of 1-50 seconds). In some embodiments the slow-moving estimate of the stationary noise component of Input may be permitted to get smaller only over a very long timescale (e.g., in the range of 1-50 seconds) and also may be permitted to get larger only over a very long timescale (e.g., in the range of 1-50 seconds). In some embodiments, the SNS circuitry 232 may be configured to implement a minimum statistics noise estimation algorithm to generate Noise_sns. In some embodiments, the SNS circuitry 232 may be further configured to implement other algorithms, in addition to or instead of the minimum statistics noise estimation algorithm, to generate Noise_sns and/or generate Mask_sns. These algorithms may include, among non-limiting examples, spectral subtraction, Wiener filtering, and Ephraim-Malah techniques. Further description of such algorithms may be found in Chung, King. “Challenges and recent developments in hearing aids: Part I. Speech understanding in noise, microphone technologies and noise reduction algorithms.” Trends in Amplification 8.3 (2004): 83-124, which is incorporated by reference herein in its entirety. In some embodiments, prior to the adaptive mixing control circuitry 228 using Noise_sns (as described below), Noise_sns may be converted from a vector (i.e., with different values for different frequencies) to a scalar. In some embodiments, this conversion may include calculating an A-weighted root-mean-square (RMS) power. In some embodiments, this may include computing the overlap between the Noise_sns vector and a vector that approximates A-weighting and calculating the RMS of the result. Calculating the RMS of the result may include squaring each element of the result, calculating the mean of the vector elements, and calculating the square root of this scalar quantity.

The multiplier 234 may be configured to multiply the output of the mixing circuitry 224 by Mask_sns to produce a denoised output. Thus, the noise reduction circuitry 212 may be configured to reduce noise using both the mask Mask_nn generated by the neural network circuitry 220 and the mask Mask_sns generated by the SNS circuitry 232.

The adaptive mixing control circuitry 228 may be configured to control the mixing performed by the mixing circuitry 224 based, at least in part, on Noise_sns, namely, the estimate of the stationary noise component of Input. In some embodiments, when controlling the mixing circuitry 224 based at least in part on Noise_sns, the adaptive mixing circuitry 228 may be configured to control the weight (a in the above description) by which Noise_nn is multiplied in the output of the mixing circuitry 224. Thus, the adaptive mixing circuitry 228 may be configured to determine based, at least in part, on the level of Noise_sns (i.e., as a function of the level of Noise_sns), the weight a. As described above, in some embodiments the mixing circuitry 224 may be configured to directly apply the weight a to Noise_nn while in other embodiments the mixing circuitry 224 may be configured to perform some other operation that results in the equivalent of a applied to Noise_nn. Controlling the weight by which Noise_nn is multiplied in the output of the mixing should be considered to include both scenarios. In some embodiments, the adaptive mixing control circuitry 228 may be configured to perform smoothing on Noise_sns prior to determining the weight. However, in some embodiments, Noise_sns may be sufficiently slow-moving such that no smoothing may need to be performed. In some embodiments, the adaptive mixing control circuitry 228 may be configured to convert the units of Noise_sns to different units (e.g., from linear units to logarithmic units) for use by the weight function. However, in some embodiments, no unit conversion may be performed. As described above, in some embodiments Noise_sns may be converted from a vector to a scalar prior to use by the weight function.

In the noise reduction circuitry 212, the amount of Noise_nn mixed back in with Speech_nn may be based, at least in part, on Noise_sns, rather than Noise_nn itself (which may be a counterintuitive approach). Noise_nn and Noise_sns may not necessarily be identical. Mixing Speech_nn and Noise_nn together using a weight based, at least in part, on the level of Noise_sns may be helpful because Noise_sns may be a slow-moving estimate of the noise, and a slow-moving estimate of the noise may help to reduce sudden jumps in the weight.

In some embodiments (and as will be described further below), rather than controlling the weight applied to Noise_nn in the mixing, the adaptive mixing circuitry 228 may be configured to control, based at least in part on Noise_sns, the relative weight applied to Noise_nn versus Speech_nn. For example, if the mixing circuitry 224 is configured to generate b*Speech_nn+a*Noise_nn, the adaptive mixing circuitry 228 may be configured to control a and/or b based on Noise_sns.

FIG. 3 illustrates noise reduction circuitry 312 (which may correspond to the noise reduction circuitry 112) in more detail, in accordance with certain embodiments described herein. The noise reduction circuitry 312 may correspond to the noise reduction circuitry 212, and the above description of the noise reduction circuitry 212 may apply to the noise reduction circuitry 312, except that the adaptive mixing control circuitry 228 may be configured to control the mixing circuitry 224 based, at least in part, on Noise_nn, namely, the neural network-predicted noise component of the input audio signal Input. Thus, in some embodiments, when controlling the mixing circuitry 224 based at least in part on Noise_nn, the adaptive mixing circuitry 228 may be configured to control the weight (a in the above description) by which Noise_nn is multiplied in the output of the mixing circuitry 224. Thus, the adaptive mixing circuitry 228 may be configured to determine based, at least in part, on the level of Noise_nn (i.e., as a function of the level of Noise_nn), the weight a. As described above, in some embodiments the mixing circuitry 224 may be configured to directly apply the weight a to Noise_nn while in other embodiments the mixing circuitry 224 may be configured to perform some other operation that results in the equivalent of a applied to Noise_nn. Controlling the weight by which Noise_nn is multiplied in the output of the mixing should be considered to include both scenarios. In some embodiments, the adaptive mixing control circuitry 228 may be configured to perform smoothing on Noise_nn prior to determining the weight. However, in some embodiments, Noise_nn may be sufficiently slow-moving such that no smoothing may need to be performed. In some embodiments, the adaptive mixing control circuitry 228 may be configured to convert the units of Noise_nn to different units (e.g., from linear units to logarithmic units) for use by the weight function. However, in some embodiments, no unit conversion may need to be performed. In some embodiments Noise_nn may be converted from a vector to a scalar (using the process described above) prior to use by the weight function.

Generally, the weight may be based, at least in part, on the level of a noise component of the input audio signal. In the example of FIG. 2, that noise component may be an estimate of the stationary noise component of the input audio signal (i.e., Noise_sns). In the example of FIG. 3, that noise component may be the neural network-predicted noise component (i.e., Noise_nn). In some embodiments, the noise component may be slow-moving and/or smoothed. It should be appreciated that, in contrast to basing the weight on SNR, in some embodiments the weight applied to the neural network-predicted noise component of the input audio signal may not be dependent on the speech component of the input audio signal. From another perspective, generally the weight applied to the neural network-predicted noise component of the input audio signal may be based on a signal that excludes a speech component of the input audio signal.

In some embodiments, the adaptive mixing control circuitry 228 may be configured to determine different weights for different frequency bands based, at least in part, on the different levels of the noise component (whether Noise_sns or Noise_nn) in the different frequency bands, and the mixing circuitry 224 may be configured to use the different weights for mixing together the different frequency bands of Speech_nn and Noise_nn. However, in some embodiments, the adaptive mixing control circuitry 228 may be configured to determine one weight based, at least in part, on one level for the noise component (e.g., averaged across all frequencies), and the mixing circuitry 224 may be configured to use the one weight for mixing together all frequencies of Speech_nn and Noise_nn. The process described above for converting a vector to a scalar may be an example of averaging across all frequencies.

In some embodiments, prior to determining the level of the noise component, the input audio signal or the noise component may be normalized. In some embodiments, prior to determining the level of the noise component, the input audio signal or the noise component may be squared. In some embodiments, prior to determining the level of the noise component, the input audio signal or the noise component may be squared and its square root taken. In some embodiments, prior to determining the level of the noise component, the input audio signal or the noise component may be converted to logarithmic units (e.g., decibels). In some embodiments, a combination of these operations may be performed. The level of the noise component may also be considered or referred to as the volume of the noise component, although as described above, different types of units may be used and still considered to be the volume.

FIGS. 4-7 illustrate example functions 400, 500, 600, and 700 of weight applied to the neural network-predicted noise component (Noise_nn) as a function of level of the noise component of the input audio signal, in accordance with certain embodiments described herein. (As described above, the weight may be directly applied to Noise_nn, or some other operation may result in the equivalent of the weight applied to Noise_nn). In some embodiments, the adaptive mixing control circuitry 228 may be configured to control the mixing circuitry 224 to use a particular weight that it determines, based on the level of the noise component of the input audio signal and the function 400, 500, 600, or 700. In some embodiments (such as the noise reduction circuitry 212), the level of the noise component of the input audio signal may be the level of Noise_sns. In some embodiments (such as the noise reduction circuitry 312), the level of the noise component of the input audio signal may be the level of Noise_nn.

Turning to FIG. 4, the following are some characteristics of the function 400: 1. When the level of the noise component of the input audio signal is equal to V₁, equal to V₂, or between V₁ and V₂, the weight is a₁ 2. When the level of the noise component of the input audio signal is lower than V₁, the weight is greater than a₁. In the example function of FIG. 4, the weight goes from a₁ to a₃ (where a₃>a₁) as the level gets progressively lower from V₁ to V₀. For levels lower than V₀, the weight is a₃ 3. When the level of the noise component of the input audio signal is higher than V₂, the weight is greater than a₁. In the example function of FIG. 4, the weight goes from a₁ to a₂ (where a₂>a₁) as the level gets progressively higher from V₂ to V₃. For levels greater than V₃, the weight is a₂ 4. a₂ and a₃ are different, and a₃>a₂.

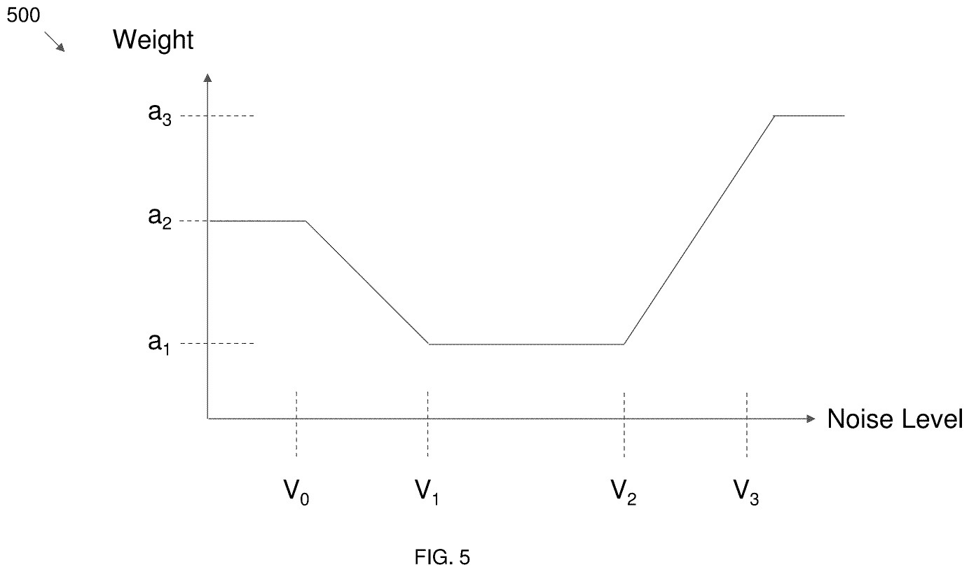

Turning to FIG. 5, the following are some characteristics of the function 500: 1. When the level of the noise component of the input audio signal is equal to V₁, equal to V₂, or between V₁ and V₂, the weight is a₁ 2. When the level of the noise component of the input audio signal is lower than V₁, the weight is greater than a₁. In the example function of FIG. 5, the weight goes from a₁ to a₂ (where a₂>a₁) as the level gets progressively lower from V₁ to V₀. For levels lower than V₀, the weight is a₂ 3. When the level of the noise component of the input audio signal is higher than V₂, the weight is greater than a₁. In the example function of FIG. 5, the weight goes from a₁ to a₃ (where a₃>a₁) as the level gets progressively higher from V₂ to V₃. For levels higher than V₃, the weight is a₃ 4. a₂ and a₃ are different, and a₃>a₂.

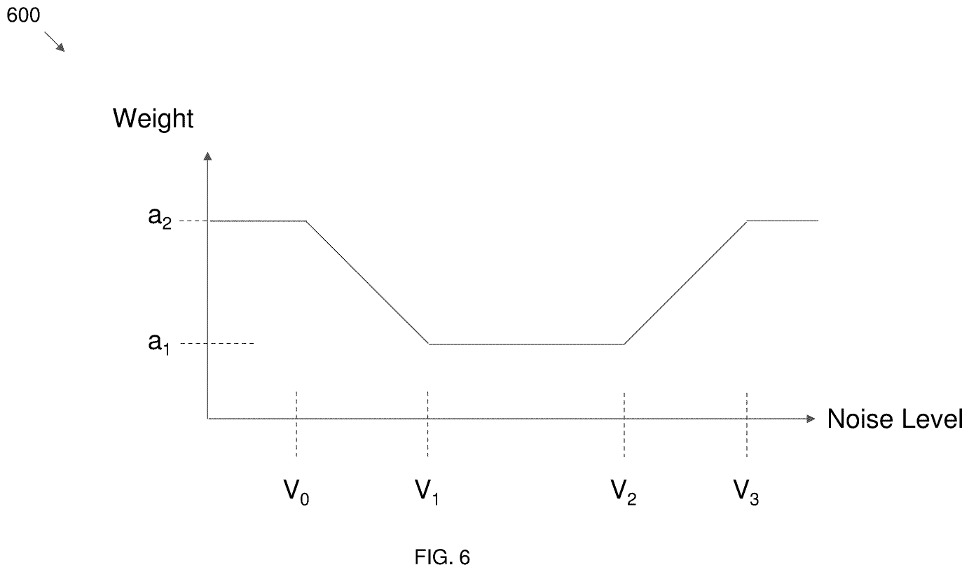

Turning to FIG. 6, the following are some characteristics of the function 600: 1. When the level of the noise component of the input audio signal is equal to V₁, equal to V₂, or between V₁ and V₂, the weight is a₁ 2. When the level of the noise component of the input audio signal is lower than V₁, the weight is greater than a₁. In the example function of FIG. 6, the weight goes from a₁ to a₂ (where a₂>a₁) as the level gets progressively smaller from V₁ to V₀. For levels lower than V₀, the weight is a₂ 3. When the level of the noise component of the input audio signal is higher than V₂, the weight is greater than a₁. In the example function of FIG. 6, the weight goes from a₁ to a₂ as the level gets progressively higher from V₂ to V₃. For levels higher than V₃, the weight is a₂.

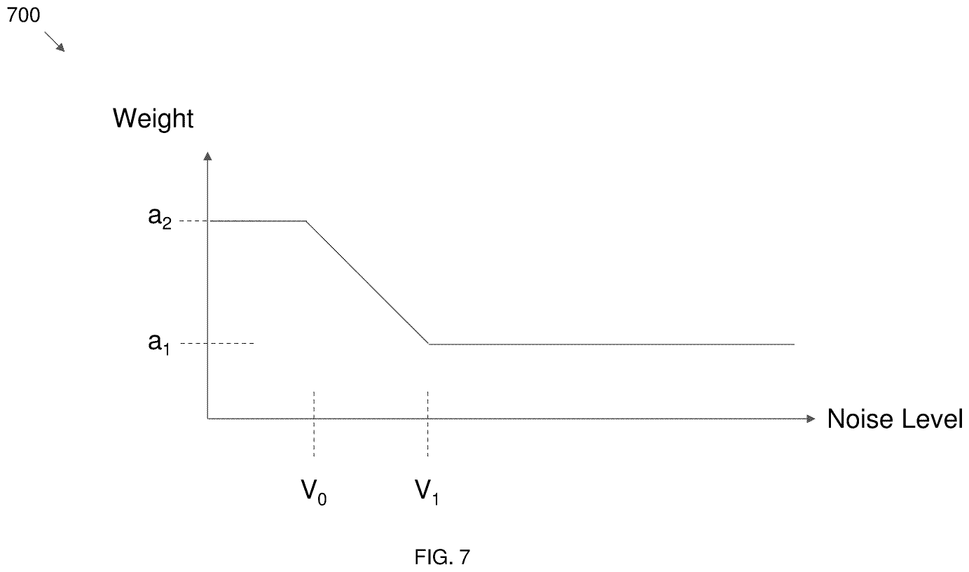

Turning to FIG. 7, the following are some characteristics of the function 700: 1. When the level of the noise component of the input audio signal is equal to or higher than V₁, the weight is a₁ 2. When the level of the noise component of the input audio signal is lower than V₁, the weight is greater than a₁. In the example function of FIG. 7, the weight goes from a₁ to a₂ (where a₂>a₁) as the level gets progressively lower from V₁ to V₀. For levels lower than V₀, the weight is a₂.

In the above example functions 400, 500, 600, and 700, in some embodiments V₀ may be in the range of 40-60 db SPL. For example, V₀ may be 50 dB SPL. In some embodiments V₁ may be in the range of 50-70 dB SPL. For example, V₁ may be 60 dB SPL. In some embodiments V₂ may be in the range of 70-90 dB SPL. For example, V₂ may be 80 dB SPL. In some embodiments V₃ may be in the range of 80-100 dB SPL. For example, V₃ may be 90 dB SPL. While these example values for the noise level use logarithmic units (i.e., decibels), in some embodiments, linear units may be used. The example values described above using decibel units may be converted into other units. In some embodiments, a₁ may be in the range of 0-0.2. For example, a₁ may be 0.1. In some embodiments, a₂ may be in the range of 0.15-0.35. For example, a₂ may be 0.25. In some embodiments, a₃ may be in the range of 0.3-0.5. For example, a₃ may be 0.4. As referred to herein, if a variable is in a range of approximately A-B, the variable may be equal to A, equal to B, approximately equal to A, approximately equal to B, or between A and B.

While the functions 400, 500, 600, and 700 are piecewise linear, in some embodiments they may be curved. While the functions 400, 500, 600, and 700 feature a flat section between V₁ and V₂, in some embodiments this section may not be flat. In other words, the weight may assume a value from a range of values when the noise level is between V₁ and V₂.

Generally, in some embodiments, the adaptive mixing circuitry 228 may be configured to determine the weight a from a first range of weight values when the noise level is higher than a first level value and determine the weight a from a second range of weight values when the noise level is lower than the first level value, where at least a portion of the weight values in the second range is greater than the weight values in the first range. For example, in FIG. 7, the first level value may be V₁, the first range of weight values may just include a₁ (as referred to herein, a range may include just a single value), the second range of weight values may extend from a₁ to a₂, and the second range includes values that are greater than the values in the first range given that a₂>>a₁. As another example, in FIG. 4, the first level value may be V₁, the first range of weight values may extend from a₁ to a₂, the second range of weight values may extend from a to as, and the second range includes values that are greater than the values in the first range given that a₃>a₂.

As referred to herein, determining the weight from a range of weight values should be understood to include that the weight may be dynamic, such that it may vary within the range based on the noise level. Thus, as the noise level varies within a range less than the first level value, the weight value may vary within the second range of weight values.

In some embodiments, the adaptive mixing circuitry 228 may be configured to determine the weight a from a first range of weight values when the noise level is higher than a first level value and lower than a second level value, and determine the weight a from a second range of weight values when the noise level is lower than the first level value, where at least a portion of the weight values in the second range is greater than the weight values in the first range. For example, in FIG. 4, the first level value may be V₁, the second value may be V₂, the first range of weight values may just include a₁, the second range of weight values may extend from a₁ to a₃, and the second range includes values that are greater than the values in the first range given that a₃>a₁. As another example, in FIG. 5, the first level value may be V₁, the second value may be V₂, the first range of weight values may just include a₁, the second range of weight values may extend from a₁ to a₂, and the second range includes values that are greater than the values in the first range given that a₂>a₁. As another example, in FIG. 6, the first level value may be V₁, the second value may be V₂, the first range of weight values may just include a₁, the second range of weight values may extend from a₁ to a₂, and the second range includes values that are greater than the values in the first range given that a₂>a₁. As another example, in FIG. 7, the first level value may be V₁, the second value may be any level greater than V₁, the first range of weight values may just include a₁, the second range of weight values may extend from a₁ to a₂, and the second range includes values that are greater than the values in the first range given that a₂>a₁.

In some embodiments, the adaptive mixing circuitry 228 may be configured to determine the weight a from a second range of weight values when the noise level is lower than a first level value, determine the weight a from a first range of weight values when the noise level is between the first level value and a second level value, and determine the weight a from a third range of weight values when the noise level is higher than the second level value. For example, the first level value may be V₁ and the second level value may be V₂. Following this example, the second range of weight values may extend from a₁ to a₃ in the function 400, extend from a₁ to a₂ in the function 500, and extend from a₁ to a₂ in the function 600. The first range of weight values may include just a₁ in the functions 400, 500, and 600. The third range of weight values may extend from a₁ to a₂ in the function 400, extend from a₁ to a₃ in the function 500, and extend from a₁ to a₂ in the function 600. It can be appreciated that continuing to follow this example, in some embodiments at least one weight value in the second range may be greater than the weight values in the first range (e.g., in the functions 400, 500, and 600). In some embodiments, at least one weight value in the second range may be greater than the weight values in the third range (e.g., in the function 400). In some embodiments, at least one weight value in the third range may be greater than the weight values in the first range (e.g., in the functions 400, 500, 600). In some embodiments, at least one weight value in the third range may be greater than the weight values in the second range (e.g., in the function 500). In some embodiments (e.g., in the functions 400 and 500), the second range of weight values may be different from the third range of weight values. In some embodiments (e.g., the function 600), the second range of weight values may be the same as the third range of weight values.

In some embodiments, at least one weight value in the first range of weight values may be equal to 0, 0.2, or between 0 and 0.2. In some embodiments, at least one weight value in the first range of weight values may be equal to 0.1. In some embodiments, at least one weight value in the second range of weight values may be equal to 0.15, 0.35, or between 0.15 and 0.35. In some embodiments, at least one weight value in the second range of weight values may be equal to 0.25. In some embodiments, at least one weight value in the second range of weight values may be equal to 0.3, 0.5, or between 0.3 and 0.5. In some embodiments, at least one weight value in the second range of weight values may be equal to 0.4. In some embodiments, at least one weight value in the third range of weight values may be equal to 0.15, 0.35, or between 0.15 and 0.35. In some embodiments, at least one weight value in the third range of weight values may be equal to 0.25. In some embodiments, at least one weight value in the third range of weight values may be equal to 0.3, 0.5, or between 0.3 and 0.5. In some embodiments, at least one weight value in the third range of weight values may be equal to 0.4. In some embodiments, the first level value may be in a range of approximately 50-70 dB SPL. In some embodiments, the first level value may be approximately equal to 60 dB SPL. In some embodiments, the second level value may be in a range of approximately 70-90 dB SPL. In some embodiments, the second level may be approximately equal to 80 dB SPL.

As described above, the inventors have recognized that it may be helpful to mix more noise together with speech when the noise volume of the environment is lower than when the noise volume of the environment is higher. This is because artifacts (e.g., due to operation of the neural network) may be more noticeable at lower noise volumes, and because less noise reduction may be necessary at lower noise volumes. As another example, the inventors have recognized that it may be helpful to mix more noise together with speech at very high noise volume environments. This is because the neural network may perform less well at very high noise volume environments and so there may be more artifacts. These relationships may be realized in functions of weight vs. noise level having a U-shape or a Z-shape, as illustrated in and described with reference to FIGS. 4-7 above.

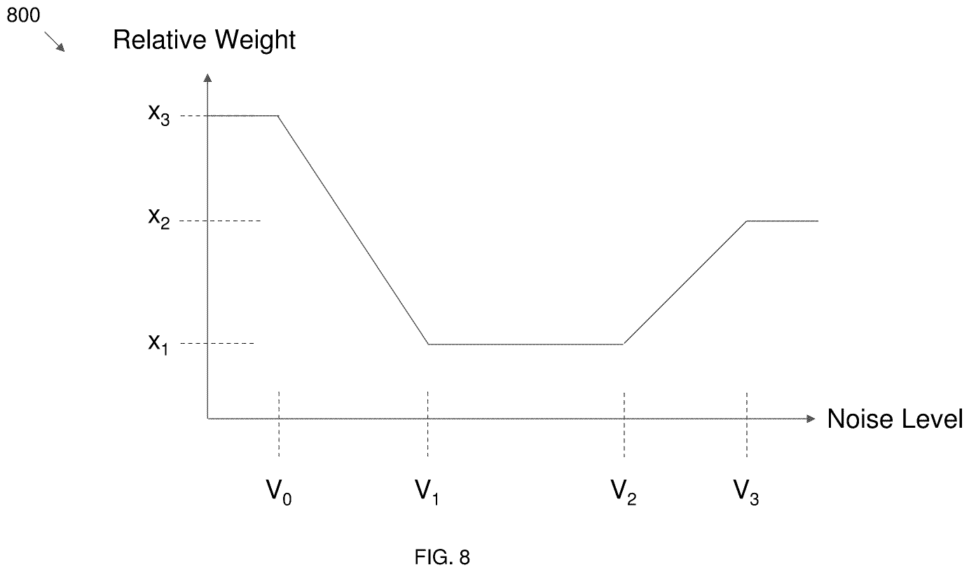

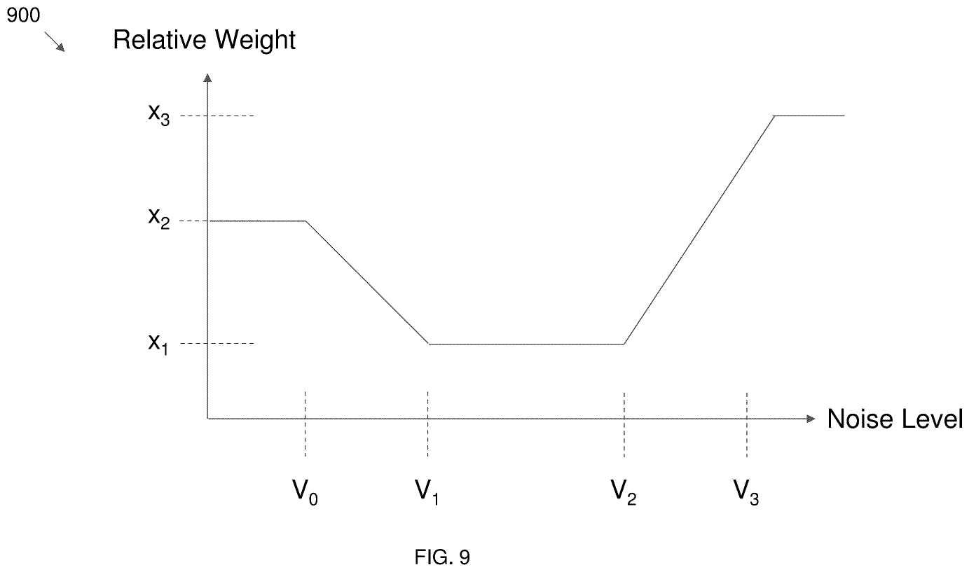

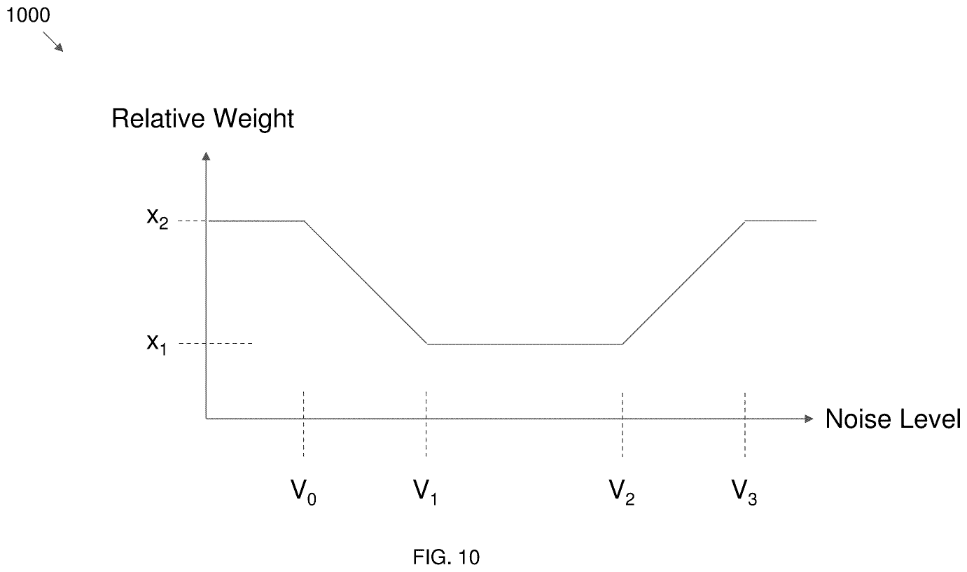

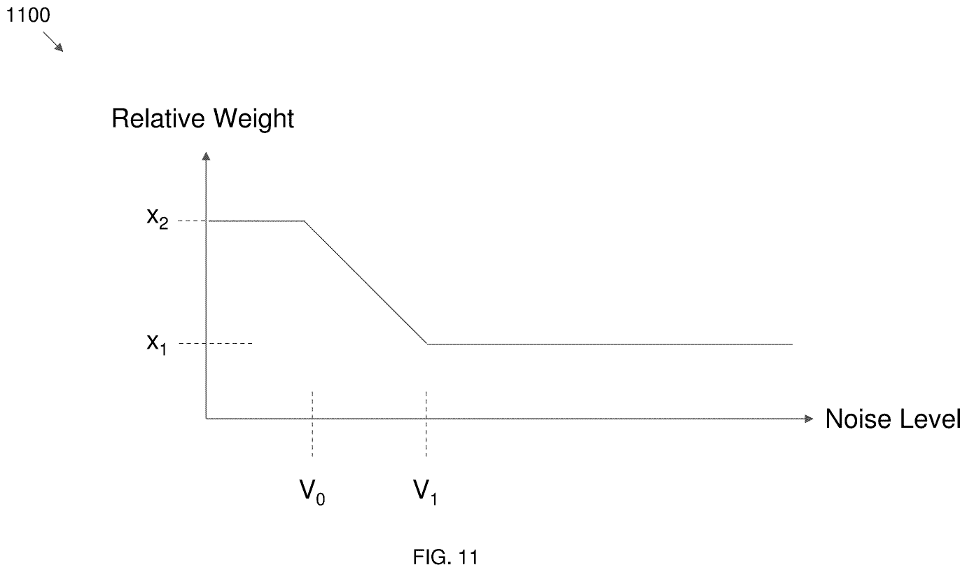

In some embodiments, the weight determined using one of the functions illustrated in FIGS. 4-7 may be the weight applied to Noise_nn in the output of the mixing circuitry 224. Thus, if the mixing circuitry 224 is configured to generate an output corresponding to Speech_nn+a″Noise_nn, the weight a may be determined based on the noise level using one of the functions illustrated in FIGS. 4-7. However, in some embodiments, the weight applied to Noise_nn in the output of the mixing circuitry 224 may be determined based on the noise level in addition to other factors. FIGS. 8-11 illustrate example functions 800, 900, 1000, and 1100 of relative weight applied to the neural network-predicted noise component (Noise_nn) versus the neural network-predicted speech component (Speech_nn) as a function of level of the noise component of the input audio signal, in accordance with certain embodiments described herein. The functions 800, 900, 1000, and 1100 are the same as the functions 400, 500, 600, and 700, respectively, and all the above description of the functions 800, 900, 1000, and 1100 applies to the functions 400, 500, 600, and 700, respectively, except that instead of the functions determining the weight a applied Speech_nn, the functions determine the relative weight applied to Noise_nn versus Speech_nn. For example, the functions illustrated in FIGS. 8-11 may determine, based on the noise level, the relative weights applied to Noise_nn versus Speech_nn, rather than determining the weight applied to Noise_nn. Thus, if the mixing circuitry 224 is configured to generate b*Speech_nn+a*Noise_nn, then the relative weight x may be determined based, at least in part, on the noise level according to the function 800, 900, 1000, or 1100, such that x equals a/b. It should be appreciated that use of the functions 800, 900, 1000, and 1100 may still be considered determining the weight applied to Noise_nn based, at least in part, on the noise level, because the relative weight x may be determined based on the noise level, and a (the weight applied to Noise_nn) may be determined based on x as well as b (the weight applied to Speech_nn). It should also be appreciated that when, in the mixing, b=1 and does not change, determining the weight a may be equivalent to determining the relative gain x=a/b. Generally, it should be appreciated that a weight may be determined partially based on the level of the noise component of the input audio signal, and partially based on other factors or metrics.

In some embodiments, rather than determining the weight based on the level of the noise component of the input audio signal, the weight may be determined based on the long-term average of the input audio signal.

In some embodiments, the beamforming circuitry 108 may be configured to phase beamforming in and out based on the level of the noise component of the input audio signal. For example, if “Beamformed” refers to a beamformed signal (e.g., a signal focused towards the front direction) and “Non_Beamformed” refers to a non-beamformed signal (e.g., a signal that is omnidirectional, in other words, not focused in any particular direction), then the output of the beamforming circuitry 108 may be x*Beamformed+(1−x)*Non_Beamformed, where x is a weight determined based on the level of the noise component of the input audio signal. As the level of the noise component increases, x may increase, and as the level of the noise component decreases, x may decrease.

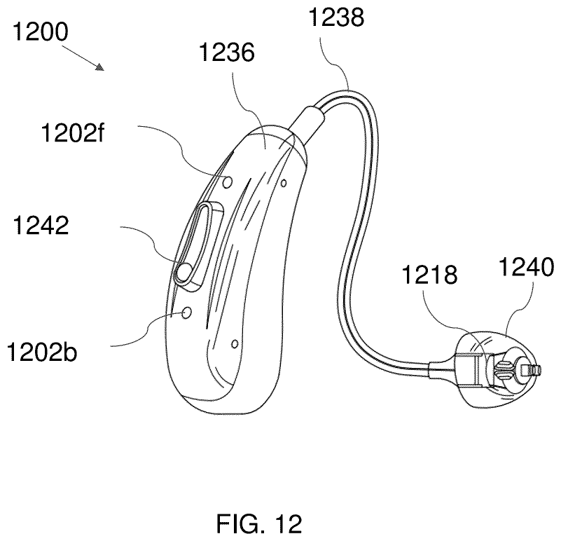

FIG. 12 illustrates a hearing aid 1200, in accordance with certain embodiments described herein. The hearing aid 1200 may be an example of the ear-worn device 100 (or generally, any ear-worn device described herein). The hearing aid 1200 is a receiver-in-canal (RIC) (also referred to as a receiver-in-the-ear (RITE)) type of hearing aid. However, any other type of hearing aid (e.g., behind-the-ear, in-the-ear, in-the-canal, completely-in-canal, open fit, etc.) may also be used. The hearing aid 1200 includes a body 1236, a receiver wire 1238, a receiver 1218, and a dome 1240. The body 1236 is coupled to the receiver wire 1238 and the receiver wire 1238 is coupled to the receiver 1218. The dome 1240 is placed over the receiver 1218. (The receiver 1218 may correspond to the receiver 118.) The body 1236 includes a front microphone 1202f, a back microphone 1202b, and a user input device 1242. (The front microphone 1202f and the back microphone 1202b may correspond to the one or more microphones 102). The body 1236 additionally includes circuitry (e.g., any of the circuitry described above, aside from the receiver 1218) not illustrated in FIG. 12. When the hearing aid 1200 is worn, the front microphone 1202f may be closer to the front of the wearer and the back microphone 1202b may be closer to the back of the wearer. The front microphone 1202f and the back microphone 1202b may be configured to receive sound signals and generate audio signals based on the sound signals. The user input device 1242 may be configured to control certain functions of the hearing aid 1200, such as switching modes. The receiver wire 1238 may be configured to transmit audio signals from the body 1236 to the receiver 1218. The receiver 1218 may be configured to receive audio signals (i.e., those audio signals generated by the body 1236 and transmitted by the receiver wire 1238) and generate sound signals based on the audio signals. The dome 1240 may be configured to fit tightly inside the wearer's ear and direct the sound signal produced by the receiver 1218 into the ear canal of the wearer.

In some embodiments, the length of the body 1236 may be equal to 2 cm, equal to 5 cm, or between 2 and 5 cm in length. In some embodiments, the weight of the hearing aid 1200 may be less than 4.5 grams. In some embodiments, the spacing between the microphones may be equal to 5 mm, equal to 12 mm, or between 5 and 12 mm. In some embodiments, the body 1236 may include a battery (not visible in FIG. 12), such as a lithium ion rechargeable coin cell battery.

This disclosure includes, at least, the following examples.

Example 1 is directed to an ear-worn device, comprising noise reduction circuitry comprising: neural network circuitry configured to determine, using a neural network, one or both of a neural network-predicted speech component of an input audio signal and a neural network-predicted noise component of the input audio signal; mixing circuitry configured to perform mixing resulting in an output signal corresponding to the neural network-predicted speech component of the input audio signal mixed with the neural network-predicted noise component of the input audio signal; and adaptive mixing control circuitry configured to control the mixing performed by the mixing circuitry based, at least in part, on: a level of an estimate of a stationary noise component of the input audio signal; and/or a level of the neural network-predicted noise component of the input audio signal.

Example 2 is directed to the ear-worn device of example 1, wherein the mixing circuitry is configured to mix the neural network-predicted speech component of the input audio signal with the neural network-predicted noise component of the input audio signal.

Example 3 is directed to the ear-worn device of example 1, wherein the mixing circuitry is configured to mix the neural network-predicted speech component of the input audio signal with the input audio signal.

Example 4 is directed to the ear-worn device of example 1, wherein the mixing circuitry is configured to mix the neural network-predicted noise component of the input audio signal with the input audio signal.

Example 5 is directed to the ear-worn device of any of examples 1-4, wherein: the mixing circuitry is configured to perform the mixing such that the output signal comprises a component comprising the neural network-predicted noise component of the input audio signal multiplied by a weight; and the adaptive mixing control circuitry is configured, when controlling the mixing performed by the mixing circuitry, to control the weight.

Example 6 is directed to the ear-worn device of example 5, wherein the adaptive mixing control circuitry is configured to: determine the weight from a first range of weight values when the level is greater than a first level value; and determine the weight from a second range of weight values when the level is lower than the first level value; wherein at least a portion of the second range of weight values is greater than the first range of weight values.

Example 7 is directed to the ear-worn device of any of examples 5-6, wherein the adaptive mixing control circuitry is configured to: determine the weight from a first range of weight values when the level is greater than a first level value and lower than a second level value; and determine the weight from a second range of weight values when the level is lower than the first level value; wherein at least a portion of the second range of weight values is greater than the first range of weight values.

Example 8 is directed to the ear-worn device of example 7, wherein the second level value is in a range of approximately 70-90 dB SPL.

Example 9 is directed to the ear-worn device of any of examples 6-8, wherein at least one weight value in the first range of weight values is equal to 0, equal to 0.2, or between 0 and 0.2.

Example 10 is directed to the ear-worn device of any of examples 6-9, wherein at least one weight value in the second range of weight values is equal to 0.15, equal to 0.35, or between 0.15 and 0.35.

Example 11 is directed to the ear-worn device of any of examples 6-9, wherein at least one weight value in the second range of weight values is equal to 0.3, equal to 0.5, or between 0.3 and 0.5.

Example 12 is directed to the ear-worn device of any of examples 6-11, wherein the first level value is in a range of approximately 50-70 dB SPL.

Example 13 is directed to the ear-worn device of example 1, wherein the adaptive mixing control circuitry is configured, when controlling the mixing performed by the mixing circuitry, to control a relative weight applied to the neural network-predicted noise component of the input audio signal versus the neural network-predicted speech component of the input audio signal in the output signal.

Example 14 is directed to the ear-worn device of example 13, wherein the adaptive mixing control circuitry is configured to: determine the relative weight from a first range of relative weight values when the level is greater than a first level value; and determine the relative weight from a second range of relative weight values when the level is lower than the first level value; wherein at least a portion of the second range of relative weight values is greater than the first range of relative weight values.

Example 15 is directed to the ear-worn device of any of examples 13-14, wherein the adaptive mixing control circuitry is configured to: determine the relative weight from a first range of relative weight values when the level is greater than a first level value and lower than a second level value; and determine the relative weight from a second range of relative weight values when the level is lower than the first level value; wherein at least a portion of the second range of relative weight values is greater than the first range of relative weight values.

Example 16 is directed to the ear-worn device of example 15, wherein the second level value is in a range of approximately 70-90 dB SPL.

Example 17 is directed to the ear-worn device of any of examples 14-16, wherein at least one relative weight value in the first range of relative weight values is equal to 0, equal to 0.2, or between 0 and 0.2.

Example 18 is directed to the ear-worn device of any of examples 14-17, wherein at least one relative weight value in the second range of relative weight values is equal to 0.15, equal to 0.35, or between 0.15 and 0.35.

Example 19 is directed to the ear-worn device of any of examples 14-18, wherein at least one relative weight value in the second range of relative weight values is equal to 0.3, equal to 0.5, or between 0.3 and 0.5.

Example 20 is directed to the ear-worn device of any of examples 14-19, wherein the first level value is in a range of approximately 50-70 dB SPL.

Example 21 is directed to the ear-worn device of any of examples 1-20, further comprising stationary noise reduction circuitry configured to generate the estimate of the stationary noise component of the input audio signal.

Example 12 is directed to the ear-worn device of example 21, wherein the stationary noise reduction circuitry is configured to generate the estimate of the stationary noise component of the input audio signal using a minimum statistics noise estimation algorithm.

Example 23 is directed to the ear-worn device of any of examples 1-22, further comprising circuitry configured to smooth the estimate of the stationary noise component of the input audio signal or the neural network-predicted noise component of the input audio signal is smoothed.

Having described several embodiments of the techniques in detail, various modifications and improvements will readily occur to those skilled in the art. Such modifications and improvements are intended to be within the spirit and scope of the invention. Accordingly, the foregoing description is by way of example only, and is not intended as limiting. For example, any components described above may comprise hardware, software or a combination of hardware and software.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The terms “approximately” and “about” may be used to mean within +20% of a target value in some embodiments, within +10% of a target value in some embodiments, within +5% of a target value in some embodiments, and yet within +2% of a target value in some embodiments. The terms “approximately” and “about” may include the target value.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Having described above several aspects of at least one embodiment, it is to be appreciated various alterations, modifications, and improvements will readily occur to those skilled in the art. Such alterations, modifications, and improvements are intended to be objects of this disclosure. Accordingly, the foregoing description and drawings are by way of example only.

1. An ear-worn device, comprising:
noise reduction circuitry comprising:
neural network circuitry configured to determine, using a neural network, one or both of a neural network-predicted speech component of an input audio signal and a neural network-predicted noise component of the input audio signal;
mixing circuitry configured to perform mixing resulting in an output signal corresponding to the neural network-predicted speech component of the input audio signal mixed with the neural network-predicted noise component of the input audio signal; and
adaptive mixing control circuitry configured to control the mixing performed by the mixing circuitry based, at least in part, on:
a level of an estimate of a stationary noise component of the input audio signal; and/or
a level of the neural network-predicted noise component of the input audio signal.

2. The car-worn device of claim 1, wherein the mixing circuitry is configured to mix the neural network-predicted speech component of the input audio signal with the neural network-predicted noise component of the input audio signal.

3. The ear-worn device of claim 1, wherein the mixing circuitry is configured to mix the neural network-predicted speech component of the input audio signal with the input audio signal.

4. The ear-worn device of claim 1, wherein the mixing circuitry is configured to mix the neural network-predicted noise component of the input audio signal with the input audio signal.

5. The ear-worn device of claim 1, wherein:
the mixing circuitry is configured to perform the mixing such that the output signal comprises a component comprising the neural network-predicted noise component of the input audio signal multiplied by a weight; and
the adaptive mixing control circuitry is configured, when controlling the mixing performed by the mixing circuitry, to control the weight.

6. The ear-worn device of claim 5, wherein the adaptive mixing control circuitry is configured to:
determine the weight from a first range of weight values when the level is greater than a first level value; and
determine the weight from a second range of weight values when the level is lower than the first level value;
wherein at least a portion of the second range of weight values is greater than the first range of weight values.

7. The ear-worn device of claim 6, wherein at least one weight value in the first range of weight values is equal to 0, equal to 0.2, or between 0 and 0.2.

8. The ear-worn device of claim 6, wherein at least one weight value in the second range of weight values is equal to 0.15, equal to 0.35, or between 0.15 and 0.35.

9. The ear-worn device of claim 6, wherein at least one weight value in the second range of weight values is equal to 0.3, equal to 0.5, or between 0.3 and 0.5.

10. The ear-worn device of claim 6, wherein the first level value is in a range of approximately 50-70 dB SPL.

11. The ear-worn device of claim 5, wherein the adaptive mixing control circuitry is configured to:
determine the weight from a first range of weight values when the level is greater than a first level value and lower than a second level value; and
determine the weight from a second range of weight values when the level is lower than the first level value;
wherein at least a portion of the second range of weight values is greater than the first range of weight values.

12. The ear-worn device of claim 11, wherein the second level value is in a range of approximately 70-90 dB SPL.

13. The ear-worn device of claim 1, wherein the adaptive mixing control circuitry is configured, when controlling the mixing performed by the mixing circuitry, to control a relative weight applied to the neural network-predicted noise component of the input audio signal versus the neural network-predicted speech component of the input audio signal in the output signal.

14. The ear-worn device of claim 13, wherein the adaptive mixing control circuitry is configured to:
determine the relative weight from a first range of relative weight values when the level is greater than a first level value; and
determine the relative weight from a second range of relative weight values when the level is lower than the first level value;
wherein at least a portion of the second range of relative weight values is greater than the first range of relative weight values.

15. The car-worn device of claim 14, wherein at least one relative weight value in the first range of relative weight values is equal to 0, equal to 0.2, or between 0 and 0.2.

16. The ear-worn device of claim 14, wherein at least one relative weight value in the second range of relative weight values is equal to 0.15, equal to 0.35, or between 0.15 and 0.35.

17. The ear-worn device of claim 14, wherein at least one relative weight value in the second range of relative weight values is equal to 0.3, equal to 0.5, or between 0.3 and 0.5.

18. The ear-worn device of claim 14, wherein the first level value is in a range of approximately 50-70 dB SPL.

19. The ear-worn device of claim 13, wherein the adaptive mixing control circuitry is configured to:
determine the relative weight from a first range of relative weight values when the level is greater than a first level value and lower than a second level value; and
determine the relative weight from a second range of relative weight values when the level is lower than the first level value;
wherein at least a portion of the second range of relative weight values is greater than the first range of relative weight values.

20. The ear-worn device of claim 19, wherein the second level value is in a range of approximately 70-90 dB SPL.

21. The ear-worn device of claim 1 further comprising stationary noise reduction circuitry configured to generate the estimate of the stationary noise component of the input audio signal.

22. The ear-worn device of claim 21, wherein the stationary noise reduction circuitry is configured to generate the estimate of the stationary noise component of the input audio signal using a minimum statistics noise estimation algorithm.

23. The ear-worn device of claim 1, further comprising circuitry configured to smooth the estimate of the stationary noise component of the input audio signal or the neural network-predicted noise component of the input audio signal is smoothed.
